(19) United States
(12) Patent Application Publication
(10) Pub. No.: US 2025/0236240 A1
(43) Pub. Date: Jul. 24, 2025

(54) TOWING MIRROR AND MIRROR FRAME THEREOF

(71) Applicant: KEN SEAN INDUSTRIES CO., LTD., Chang-Hua (TW)

(72) Inventor: Sheng-Hung CHEN, Changhua County (TW)

(73) Assignee: KEN SEAN INDUSTRIES CO., LTD., Chang-Hua (TW)

(21) Appl. No.: 18/828,260

(22) Filed: Sep. 9, 2024

(30) Foreign Application Priority Data
Jan. 23, 2024 (TW) 113200829

(51) Int. Cl. B60R 1/078

(52) U.S. Cl. CPC B60R 1/078

(57) ABSTRACT

A mirror frame of a towing mirror includes a mounting seat, an engaging member, and a retaining set. The mounting seat includes a seat body, at least one first inverted hook, and an engaging structure that has a stopping portion. The stopping portion and the seat body cooperatively define a passage. The engaging member is detachably mounted to the engaging structure and has an engaging plate adapted for engaging the engaging structure. The engaging plate has a hook portion adapted for passing through the passage and engaging the stopping portion. The retaining set has a resilient arm and a guiding block adapted for pushing the resilient arm. The resilient arm is formed with a protrusion. The guiding block has a guiding inclined surface that faces the protrusion and that presses the protrusion to make the resilient arm resiliently bend.

### CROSS-REFERENCE TO RELATED APPLICATION

This application claims priority to Taiwanese Utility Model Patent Application No. 113200829, filed on Jan. 23, 2024, the entire disclosure of which is incorporated by reference herein.

### FIELD

The disclosure relates to a vehicle accessory, and more particularly to a towing mirror and a mirror frame thereof.

### BACKGROUND

A towing mirror is an expansion device mounted to a vehicle rearview mirror to extend a field of view of the vehicle rearview mirror, so as to expand the visible range of a driver and to thereby enhance driving safety.

For example, a fastening apparatus disclosed in Taiwanese Invention Patent No. TWI256358B is adapted for an auxiliary rearview mirror and includes a fastening body and two strap bodies. The fastening apparatus can fasten an auxiliary rearview mirror and a frame to a vehicle rearview mirror by a fastening seat, so that the auxiliary rearview mirror may extend a field of view of the vehicle rearview mirror. However, the fastening apparatus has many components, and manufacturing and assembly thereof are complicated; in addition, the strap bodies each are formed with a plurality of inclined teeth for being engaged with the fastening body, which results in high production cost.

### SUMMARY

Therefore, an object of the disclosure is to provide a towing mirror and a mirror frame thereof that can alleviate at least one of the drawbacks of the prior art.

According to one aspect of the disclosure, the mirror frame of a towing mirror is adapted to be mounted to a vehicle mirror, and includes a mounting seat, an engaging member, and a retaining set. The mounting seat includes a seat body that borders a cavity adapted for accommodating the vehicle mirror, at least one first inverted hook that is formed on the seat body and that is adapted for hooking a side of the vehicle mirror, and an engaging structure that is formed on a side of the seat body opposite to the at least one first inverted hook, that is formed with an accommodating space having an opening, and that has a stopping portion adjacent to the opening. The stopping portion and the seat body cooperatively define a passage in the accommodating space. The engaging member is detachably mounted to the engaging structure of the mounting seat, is adapted for hooking another side of the vehicle mirror, and has a second inverted hook that is adapted for hooking the another side of the vehicle mirror and an engaging plate that is adapted for engaging the engaging structure. The engaging plate has a hook portion that is adapted for passing through the passage and engaging the stopping portion of the engaging structure. The retaining set has a resilient arm that is resiliently pushable and a guiding block that is adapted for pushing the resilient arm. The resilient arm is disposed on one of the seat body and the engaging member and is formed with a protrusion. The guiding block is disposed on another one of the seat body and the engaging member and has a guiding inclined surface that faces the protrusion and that presses the protrusion to make the resilient arm resiliently bend.

According to another aspect of the disclosure, a towing mirror is adapted for being mounted to a vehicle mirror, and includes the abovementioned mirror frame and an auxiliary mirror that is mounted to the mounting seat of the mirror frame and that is adjacent to the vehicle mirror.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating a first embodiment of a towing mirror that is mounted to a vehicle mirror according to the disclosure.

FIG. 2 is an exploded perspective view of the first embodiment.

FIG. 3 is a fragmentary enlarged perspective view of the first embodiment.

FIG. 4 is another fragmentary enlarged perspective view of the first embodiment.

FIG. 5 is an exploded perspective view of FIG. 4.

FIG. 6 is a partly sectional fragmentary perspective view of the first embodiment, illustrating a mounting seat.

FIG. 7 is a fragmentary sectional perspective view of the first embodiment, illustrating an engaging member that is mounted to the mounting seat.

FIG. 8 is a fragmentary sectional view of the first embodiment, illustrating the engaging member that is mounted to the mounting seat.

FIG. 9 is a perspective view of the engaging member of the first embodiment.

FIG. 10 is view similar to FIG. 6, but with a portion of the engaging member being mounted to the mounting seat.

FIGS. 11A to 11C are fragmentary schematic sectional views illustrating that the engaging member is being mounted to the mounting seat.

FIGS. 12A to 12C are fragmentary schematic sectional views illustrating that the engaging member is being detached from the mounting seat.

FIG. 13 is a fragmentary exploded perspective view of a second embodiment of the towing mirror according to the disclosure.

FIG. 14 is a perspective view of the engaging member of the second embodiment.

FIG. 15 is a fragmentary sectional view of the second embodiment, illustrating the engaging member that is mounted to the mounting seat.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

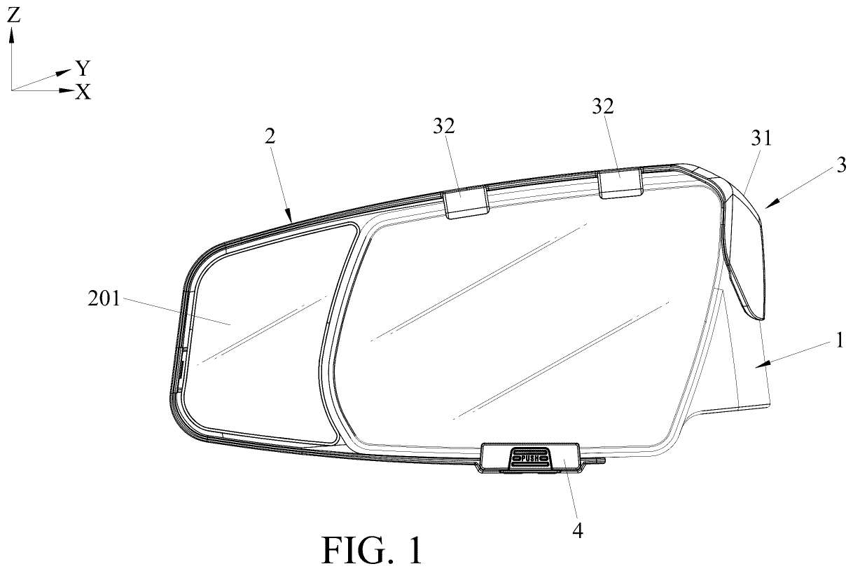

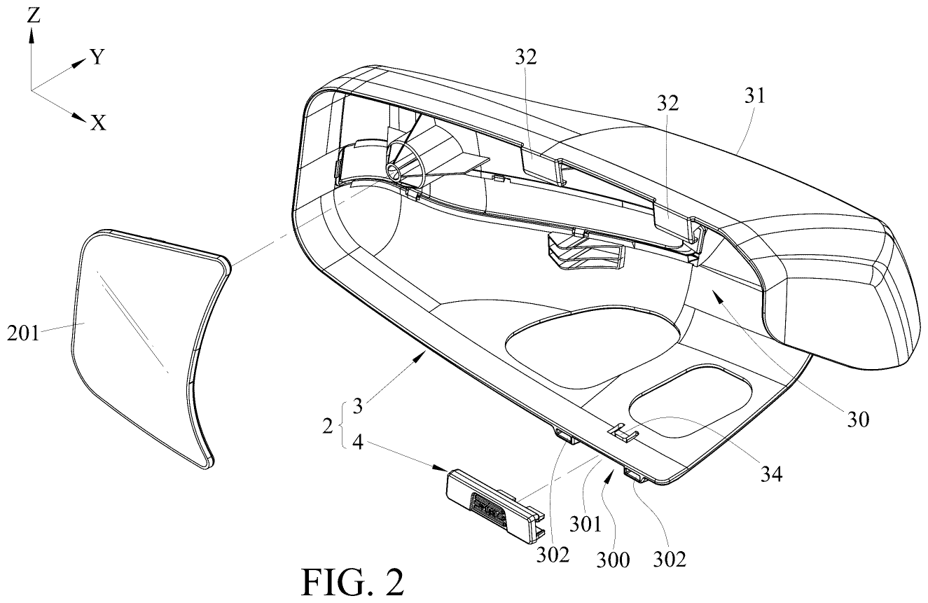

Referring to FIGS. 1 and 2, a first embodiment of a towing mirror according to the disclosure is adapted for being mounted to a vehicle mirror 1, and includes a mirror frame 2 and an auxiliary mirror 201. The vehicle mirror 1 is a rearview mirror that is installed outside a vehicle, and in FIG. 1, a frame of the vehicle mirror 1 connected to the vehicle is omitted. The auxiliary mirror 201 is mounted to the mirror frame 2 and is adjacent to the vehicle mirror 1.

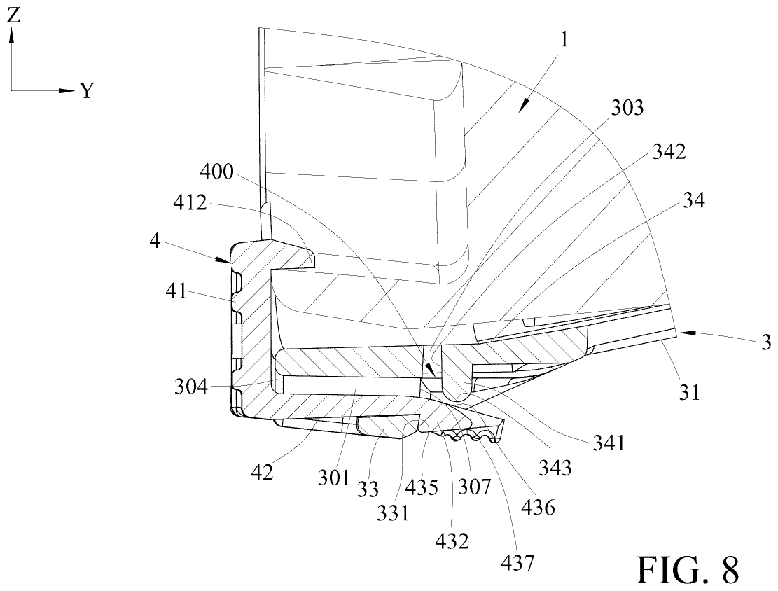

The mirror frame 2 includes a mounting seat 3 adapted for being mounted to the vehicle mirror 1 and adapted for the auxiliary mirror 201 to be mounted thereto, an engaging member 4 adapted for fixing the mounting seat 3 to the vehicle mirror 1, and a retaining set 400 (see FIG. 8). The auxiliary mirror 201 is mounted to the mounting seat 3 of the mirror frame.

The mounting seat 3 is made of a plastic material and includes a seat body 31, at least one first inverted hook 32, and an engaging structure 300. In this embodiment, the at least one first inverted hook 32 is two first inverted hooks 32. The seat body 31 borders a cavity 30 adapted for accommodating the vehicle mirror 1 and the auxiliary mirror 201. In a top-bottom direction (Z), the first inverted hooks 32 are formed on a side of the seat body 31 (i.e., a top side of the seat body 31 in this embodiment) and are adapted for hooking a side of the vehicle mirror 1 (i.e., a top side of the vehicle mirror 1 in this embodiment), and are spaced apart from each other in a left-right direction (X) perpendicular to the top-bottom direction (Z). The engaging structure 300 is formed on a side of the seat body 31 opposite to the first inverted hooks 32 (i.e., a bottom side of the seat body 31 in this embodiment) in the top-bottom direction (Z). In some embodiments, the at least one first inverted hook 32 may be one first inverted hook 32, and has the same effect of hooking the top side of the vehicle mirror 1.

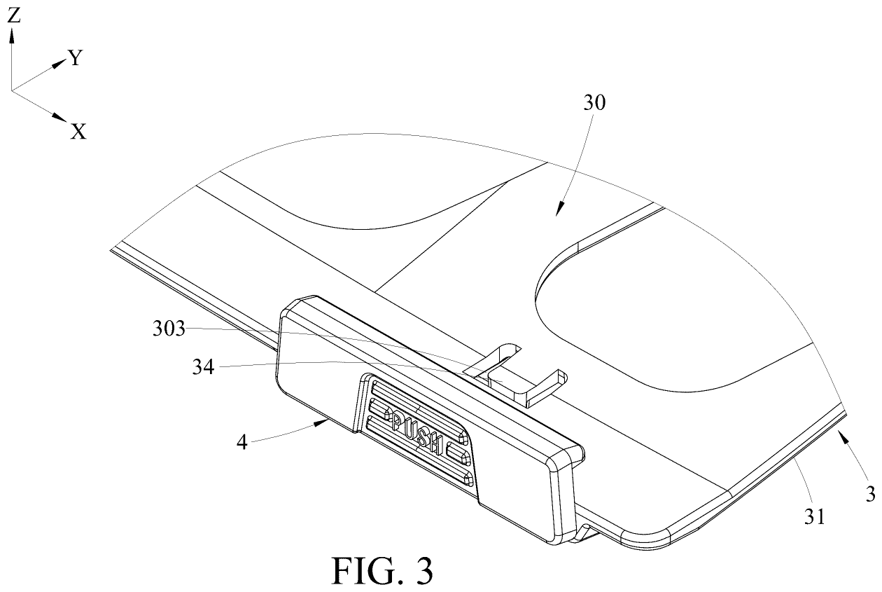

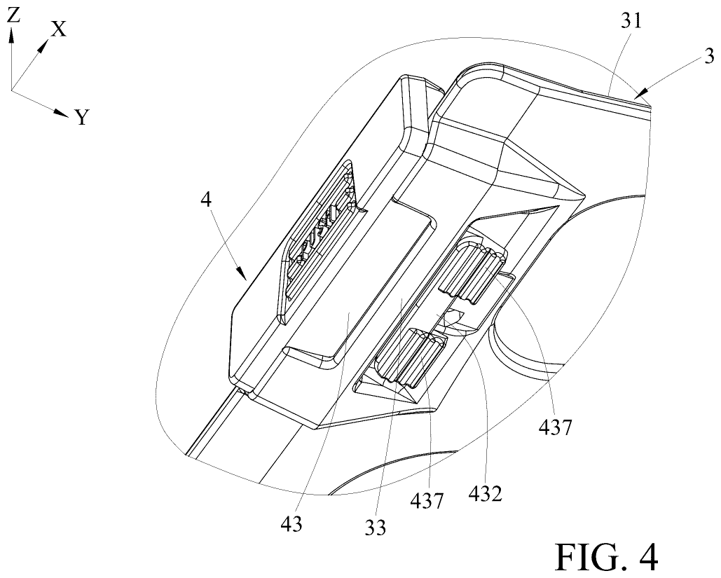

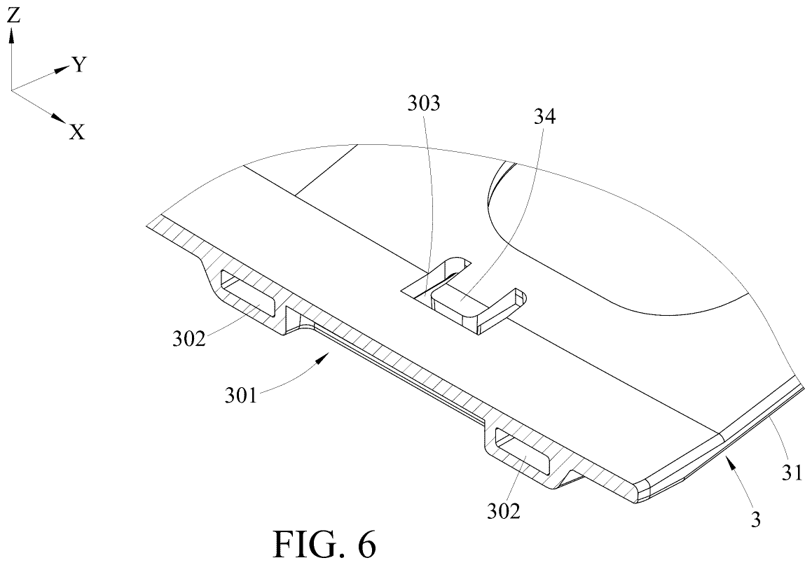

Referring to FIGS. 3 to 6, the engaging structure 300 is formed with an accommodating space 301 having an opening 304, and two engaging holes 302 respectively disposed at two opposite sides of the accommodating space 301 in the left-right direction (X), and includes a resilient arm 34 disposed on one of the seat body 31 and the engaging member 4. In the first embodiment, the resilient arm 34 is disposed on the seat body 31, and the engaging structure 300 is further formed with a slot 303 disposed on the seat body 31 and spatially communicating with the accommodating space 301 and the cavity 30.

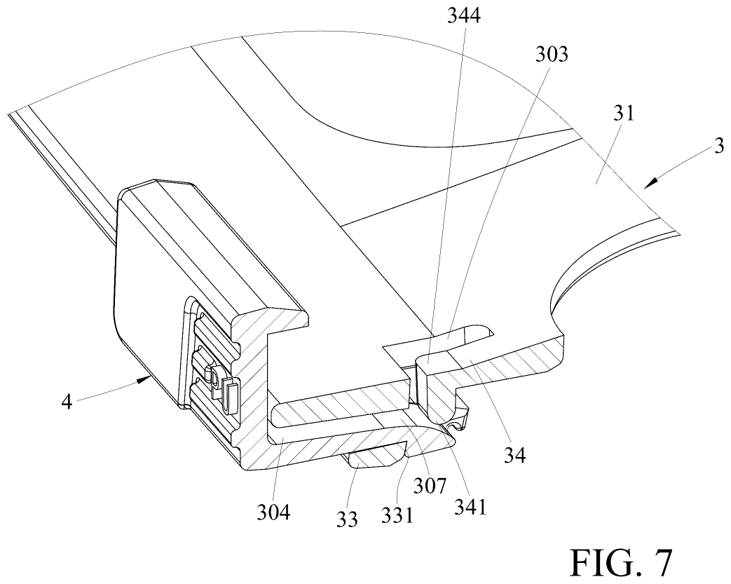

Referring to FIGS. 3, 5, 7, and 8, the engaging structure 300 further includes a stopping portion 33 adjacent to the opening 304; specifically, the stopping portion 33 is disposed between the opening 304 and the slot 303. The resilient arm 34 is disposed on the seat body 31, extends from the seat body 31 into the slot 303, and is resiliently pushable. The stopping portion 33 is a cross beam extending in the left-right direction (X) and has a stopping surface 331 opposite to the opening 304 in a first direction (Y) that is perpendicular to the left-right direction (X) and the top-bottom direction (Z). The resilient arm 34 has a side that is connected integrally to the seat body 31, extends in the first direction (Y), and can be resiliently bent due a property of the plastic material. The resilient arm 34 has an end located in the slot 303 and formed with a protrusion 341 that is adjacent to the stopping portion 33. The protrusion 341 is substantially semi-cylindrical shaped, and includes an outer surface 342 facing the opening 304 and extending in the top-bottom direction (Z), and a resilient abutting surface 343 connected to the outer surface 342 and extending substantially in the first direction (Y) (see FIG. 8). The stopping portion 33 and the seat body 31 cooperatively define a passage 307 that is adjacent to the slot 303 in the accommodating space 301. When the resilient arm 34 is not resiliently pushed (i.e., in an original position), a top surface 344 of the resilient arm 34 is flush with a surface of the seat body 31.

Referring to FIGS. 8 to 10, the engaging member 4 is made of a plastic material, is detachably mounted to the engaging structure 300 of the mounting seat 3 in the first direction (Y), and is adapted for hooking another side of the vehicle mirror 1 in the top-bottom direction (Z) (i.e., a bottom side of the vehicle mirror 1 in this embodiment).

The engaging member 4 includes a fixing plate 41, and an engaging plate set 42 extending from the fixing plate 41 toward the engaging structure 300. The fixing plate 41 includes a fixing wall 411 extending in the top-bottom direction (Z), and a second inverted hook 412 formed on a side of the fixing plate 41 opposite to the engaging plate set 42. Specifically, the second inverted hook 412 is formed on a side of the fixing wall 411 opposite to the engaging plate set 42 in the top-bottom direction (Z) and adapted for hooking the another side of the vehicle mirror 1 (i.e., the bottom side). The engaging plate set 42 includes an engaging plate 43 adapted for extending into the accommodating space 301 and engaging the engaging structure 300, and two engaging blocks 44 respectively disposed on two opposite sides of the engaging plate 43 and adapted for being inserted into the engaging holes 302. The engaging plate 43 includes a connecting wall 431 extending in the first direction (Y) from a side of the fixing wall 411 that is opposite to the second inverted hook 412 in the top-bottom direction (Z), and a hook portion 432 formed at a side of the connecting wall 431, and adapted for passing through the passage 307 and engaging the stopping portion 33. A side of the hook portion 432 is not aligned with the outer surface 342 of the protrusion 341 in the first direction (Y) in a cross-section of the first embodiment (see FIG. 8); specifically, the outer surface 342 is more adjacent to the opening 304 than the side of the hook portion 432. The hook portion 432 includes two protruding blocks 433 that are spaced apart from each other and that are adapted for engaging the stopping portion 33 and abutting against the stopping surface 331, and a guiding block 434 that is disposed on another one of the seat body 31 and the engaging member 4. In the first embodiment, the guiding block 434 is disposed on the hooked portion 432, is disposed between the protruding blocks 433 and corresponds in position to the protrusion 341 in the top-bottom direction (Z). Specifically, in the first embodiment, the guiding block 434 is disposed straightforwardly below the protrusion 341.

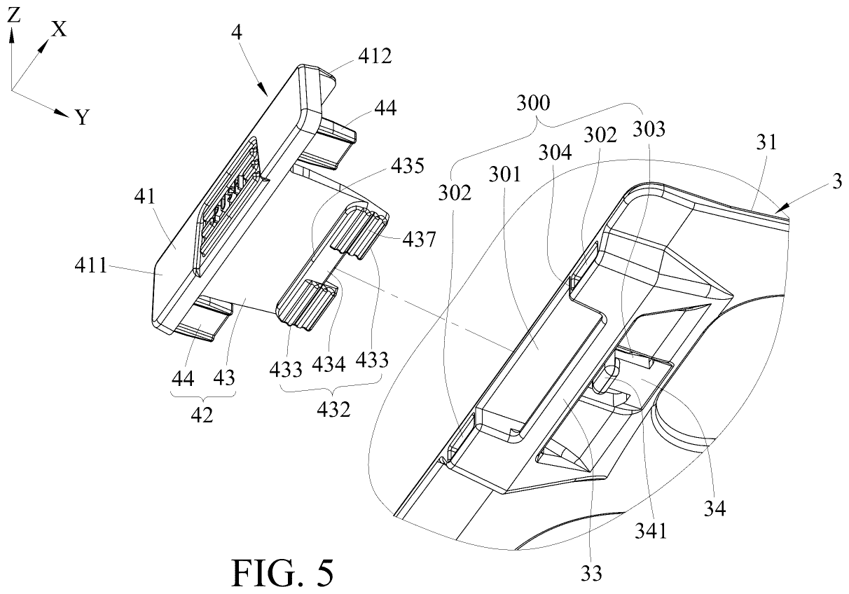

Referring to FIGS. 5, 8 and 9, the protruding blocks 433 and the guiding block 434 cooperatively define a hooking surface 435 engaging the stopping surface 331 and facing the opening 304. The guiding block 434 is formed with a guiding inclined surface 436 which faces the protrusion 341, along which the protrusion 341 is slidable, and which presses the protrusion 341 to make the resilient arm 34 resiliently bend. The guiding inclined surface 436 is inclined relative to an imaginary plane, to which the top-bottom direction (Z) is perpendicular, by an angle that is greater than an angle by which a surface of each of the protruding blocks 433 adjacent to the second inverted hook 412 is inclined relative to the imaginary plane, so that when the engaging member 4 is mounted to the engaging structure 300, the protruding blocks 433 and the guiding block 434 can pass smoothly through the passage 307, and the guiding block 434 can smoothly slide through the resilient abutting surface 343 of the protrusion 341.

In this embodiment, each of the protruding blocks 433 has a length that is greater than a length of the guiding block 434 in the first direction (Y). Each of the protruding blocks 433 has a teeth structure 437, which is composed of a plurality of ridges. By virtue of the design of the teeth structure 437, when a user applies force on the protruding blocks 433 to detach the engaging member 4 from the engaging structure 300, the protruding blocks 433 may not easily slide away. In some embodiments, the length of each of the protruding blocks 433 may be not greater than the length of the guiding block 434 in the first direction (Y). In some embodiments, the teeth structure 437 of each of the protruding blocks 433 may be omitted.

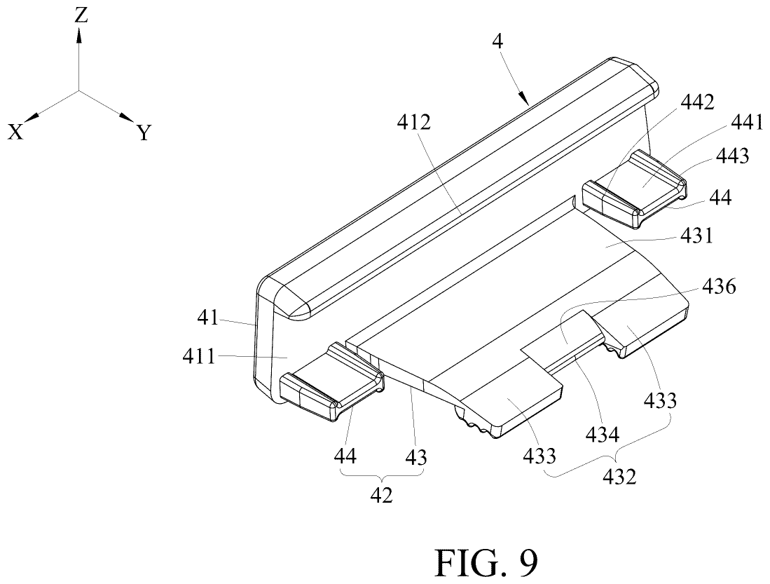

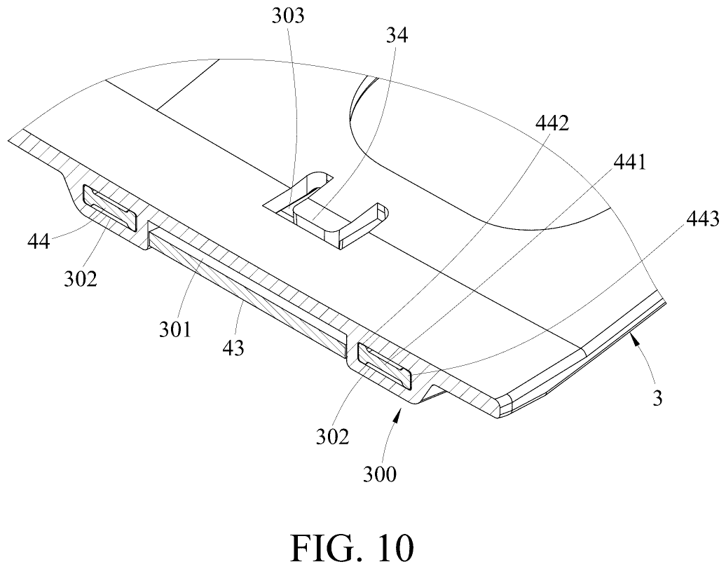

Referring to FIGS. 9 and 10, the engaging blocks 44 are respectively disposed on the two opposite sides of the engaging plate 43, are spaced apart from the engaging plate 43, and are respectively inserted into the engaging holes 302. In this embodiment, each of the engaging blocks 44 has a block body 441, and first and second side portions 442, 443 that are respectively connected to two opposite sides of the block body 441 and that protrude out of the block body 441. Specifically, for each of the engaging blocks 44, each of the first and second side portions 442, 443 has a height that is greater than a height of the block body 441 in the top-bottom direction (Z). That is, a cross-section of each of the engaging blocks 44 is H-shaped, and when each of the engaging blocks 44 is inserted into the respective one of the engaging holes 302, such configuration results in a guiding and positioning effect.

In the first direction (Y), each of the engaging blocks 44 has a length that is smaller than a length of the engaging plate 43. In some embodiments, the engaging blocks 44 may include holes, and the engaging holes 302 may be blocks; that is, when the engaging member 4 is mounted to the engaging structure 300, the blocks 302 are respectively inserted into the holes of the engaging blocks 44.

Referring to FIG. 8, the retaining set 400 contains the slot 303, the resilient arm 34, and the guiding block 434 that is adapted for pushing the resilient arm 34. In the first embodiment, the slot 303 and the resilient arm 34 are disposed on the seat body 31, and the guiding block 434 is disposed on the hook portion 432 of the engaging member 4.

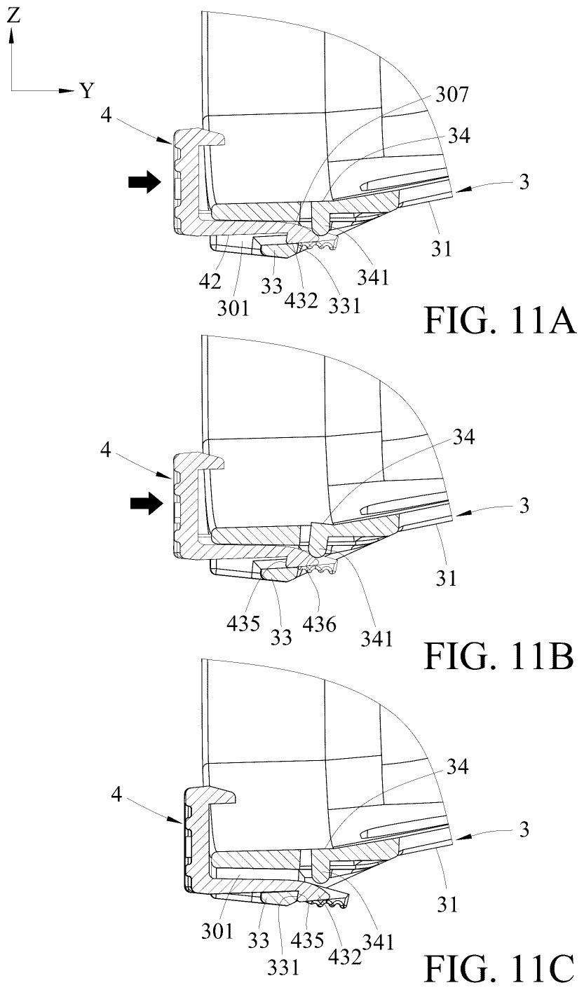

As shown in FIG. 2 and FIGS. 11A to 11C, when the engaging member 4 is mounted to the mounting seat 3 to secure the first embodiment onto the vehicle mirror 1 (not shown), the engaging plate set 42 of the engaging member 4 enters the accommodating space 301 and the engaging holes 302 in the first direction (Y). The engaging member 4 can be slightly inclined before being mounted to the mounting seat 3 for easier installation. When the guiding inclined surface 436 of the hook portion 432 of the engaging plate 43 (see FIG. 9) abuts against the protrusion 341 of the resilient arm 34, the guiding inclined surface 436 can slidably press the protrusion 341 to allow the resilient arm 34 to be resiliently bent. Specifically, the protrusion 341 is pushed upward, so that the hook portion 432 can pass through the passage 307, and after the hooking surface 435 of the hook portion 432 exceeds the stopping surface 331 of the stopping portion 33, the hook portion 432 is lowered to engage the hooking surface 435 directly with the stopping surface 331 of the stopping portion 33, and the resilient arm 34 returns to the original position.

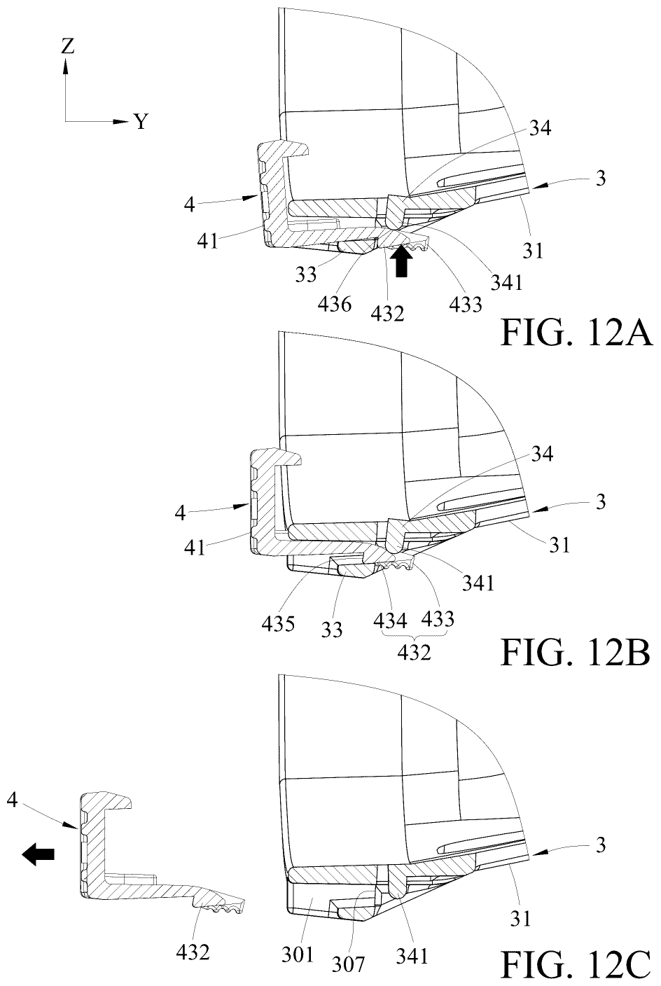

As shown in FIGS. 12A to 12C, when the engaging member 4 is detached from the mounting seat 3, a user only has to use fingers to push and press the protruding blocks 433 of the engaging member 4, which makes the hook portion 432 move toward the projection 341. Then, the guiding inclined surface 436 presses and pushes the projection 341 to make the resilient arm 34 resiliently bend, so that the hook portion 432 is allowed to be disengaged from the stopping portion 33 (i.e., the hooking surface 435 no longer abuts against the stopping surface 331), and to be removed from the accommodating space 301, and the engaging member 4 can be detached from the mounting seat 3. The disclosure has a simple structure and facilitates installation and removal thereof without using additional tools.

In the first embodiment, the engaging member 4 can be detachably mounted to the engaging structure 300 of the mounting seat 3 and hook the vehicle mirror 1. The engaging member 4 is mounted to the mounting seat 3 by engaging the hook portion 432 with the stopping portion 33. When the engaging member 4 is to be detached from the mounting seat 3, the user only has to use fingers to push and press the hook portion 432 of the engaging member 4, which makes the guiding inclined surface 436 of the hook portion 432 press and push the projection 341 and allows the resilient arm 34 to resiliently bend, so that the hook portion 432 can be disengaged from the stopping portion 33 (i.e., the hooking surface 435 no longer abuts against the stopping surface 331), and can be removed from the accommodating space 301. The first embodiment has a simple structure and has an effect of being easily detached.

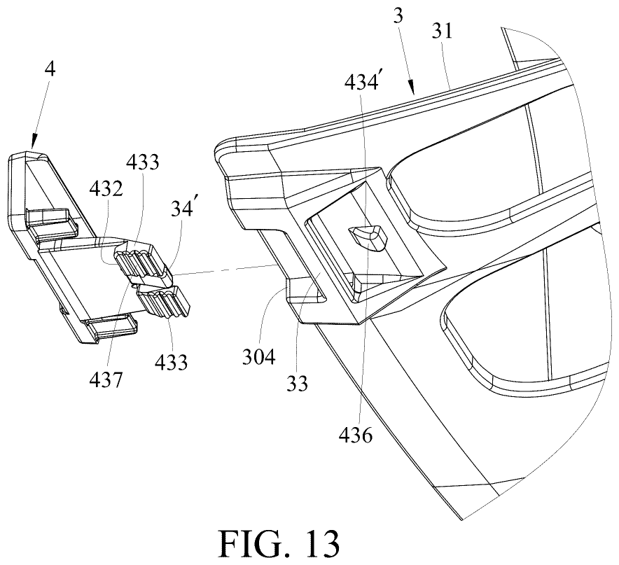

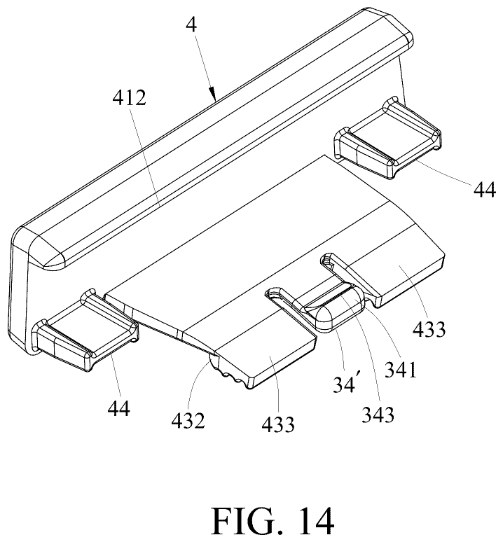

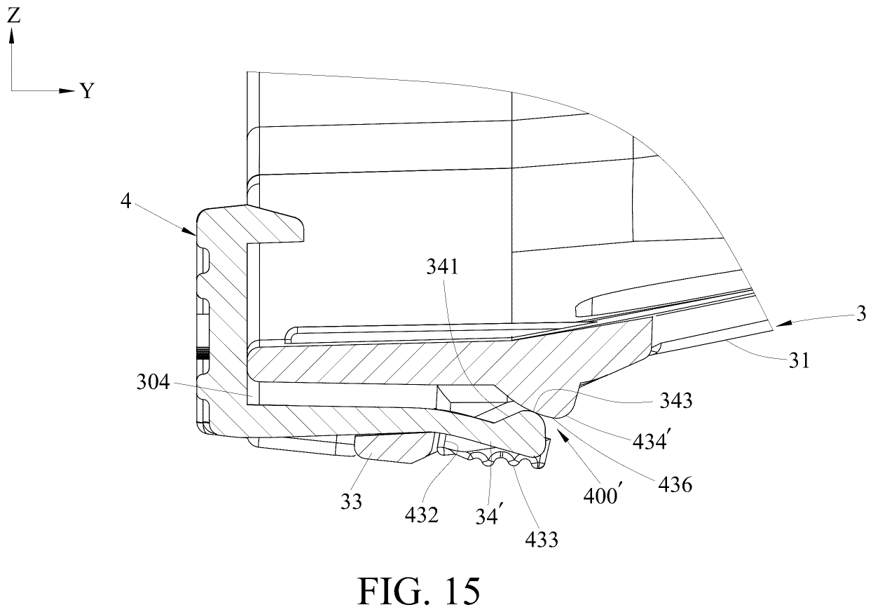

Referring to FIGS. 13 to 15, a second embodiment of the present disclosure is illustrated. Differences between the first and second embodiment are in the following. In the second embodiment, the retaining set 400′ contains the resilient arm 34′ and the guiding block 434′. The resilient arm 34′ is disposed on the hook portion 432 of the engaging member 4 and between the protruding blocks 433 of the hook portion 432, and is spaced apart from the protruding blocks 433. The resilient abutting surface 343 of the protrusion 341 of the resilient arm 34′ is opposite to the teeth structure 437 of the hook portion 432. The guiding block 434′ is disposed on the seat body 31 and at a side of the stopping portion 33 away from the opening 304. The guiding block 434′ is disposed above the protrusion 341 in the top-bottom direction (Z). The guiding inclined surface 436 of the guiding block 434′ is configured for the resilient abutting surface 343 of the protrusion 341 to frictionally slide.

In the second embodiment, similarly, the hook portion 432 engages the stopping portion 33 to make the engaging member 4 be fixedly mounted to the engaging structure 300 of the mounting seat 3. When the engaging member 4 is to be detached from the mounting seat 3, the user only has to use fingers to push and press the protruding blocks 433 of the hook portion 432 of the engaging member 4, which makes the hook portion 432 be disengaged from the stopping portion 33, and the engaging member 4 can be detached from the mounting seat 3. The second embodiment has a simple structure and has an effect of being easily detached as well.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A mirror frame of a towing mirror, adapted to be mounted to a vehicle mirror, said mirror frame comprising:
a mounting seat including
a seat body that borders a cavity adapted for accommodating the vehicle mirror,
at least one first inverted hook that is formed on said seat body and that is adapted for hooking a side of the vehicle mirror, and
an engaging structure that is formed on a side of said seat body opposite to said at least one first inverted hook, that is formed with an accommodating space having an opening, and that has a stopping portion adjacent to said opening, said stopping portion and said seat body cooperatively defining a passage in said accommodating space;
an engaging member detachably mounted to said engaging structure of said mounting seat, adapted for hooking another side of the vehicle mirror, and having a second inverted hook that is adapted for hooking the another side of the vehicle mirror, and an engaging plate that is adapted for engaging said engaging structure, said engaging plate having a hook portion that is adapted for passing through said passage and engaging said stopping portion of said engaging structure; and
a retaining set containing a resilient arm that is resiliently pushable and a guiding block that is adapted for pushing said resilient arm, said resilient arm being disposed on one of said seat body and said engaging member and being formed with a protrusion, said guiding block being disposed on another one of said seat body and said engaging member and having a guiding inclined surface that faces said protrusion and that presses said protrusion to make said resilient arm resiliently bend.

2. The mirror frame of a towing mirror as claimed in claim 1, wherein said retaining set further contains a slot that is disposed on said seat body and that spatially communicates with said accommodating space, said resilient arm being disposed on said seat body and extending into said slot, said guiding block being disposed on said hook portion of said engaging member.

3. The mirror frame of a towing mirror as claimed in claim 1, wherein said resilient arm is disposed on said hook portion of said engaging member, and said guiding block is disposed on said seat body and at a side of said stopping portion away from said opening.

4. The mirror frame of a towing mirror as claimed in claim 1, wherein said engaging structure is further formed with two engaging holes that are respectively disposed at two opposite sides of said accommodating space, and said engaging member further has two engaging blocks that are respectively disposed on two opposite sides of said engaging plate and that are adapted for being inserted into said engaging holes.

5. The mirror frame of a towing mirror as claimed in claim 4, wherein each of said engaging blocks has a block body, and first and second side portions that are respectively connected to two opposite sides of said block body and that protrude out of said block body.

6. The mirror frame of a towing mirror as claimed in claim 4, wherein said engaging member includes a fixing plate and an engaging plate set that extends from said fixing plate toward said engaging structure, said engaging plate set including said engaging plate and said engaging blocks, said second inverted hook being formed on a side of said fixing plate opposite to said engaging plate set, said engaging blocks being spaced apart from said engaging plate.

7. The mirror frame of a towing mirror as claimed in claim 4, wherein in a first direction, each of said engaging blocks has a length that is smaller than a length of said engaging plate.

8. The mirror frame of a towing mirror as claimed in claim 1, wherein said stopping portion has a stopping surface, said hook portion having two protruding blocks that are spaced apart from each other, and that are adapted for engaging said stopping portion and abutting against said stopping surface.

9. The mirror frame of a towing mirror as claimed in claim 8, wherein each of said protruding blocks has a teeth structure.

10. A towing mirror adapted for being mounted to a vehicle mirror, said towing mirror comprising:
said mirror frame as claimed in claim 1; and
an auxiliary mirror mounted to said mounting seat of said mirror frame and adjacent to the vehicle mirror.
